(19) United States
(12) Patent Application Publication
(10) Pub. No.: US 2003/0134916 A1
(43) Pub. Date: Jul. 17, 2003

(54) Lightweight, high strength carbon aerogel composites and method of fabrication

(75) Inventor: Lawrence W. Hrubesh, Pleasanton, CA (US)

Correspondence Address: Alan H. Thompson, Assistant Laboratory Counsel, Lawrence Livermore National Laboratory, P.O. Box 808, L-703, Livermore, CA, 94551, US

(73) Assignee: The Regents of the University of California

(21) Appl. No.: 10/050,437

(22) Filed: Jan. 15, 2002

(51) Int. Cl. C08J 9/00

(52) U.S. Cl. 521/50

(57) ABSTRACT

A lightweight, high strength carbon aerogel composite and method of producing such a composite. An organic gel precursor is infiltrated into a pre-formed organic polymer foam or fiber-mat where it gels. The gel composite is then dried by any method that limits the shrinkage of the composite material. The dried gel is then heated in a furnace to pyrolyze the composite, reducing it to a glassy carbon form. The structure of the final carbon product consists of a matrix of porous carbon aerogel, reinforced by solid carbon struts, or fibers all in intimate contact, so that the strength of the composite is maximized.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

The present invention relates to aerogel material, particularly to aerogel composites, and more particularly to lightweight, high strength carbon aerogel composites and method of fabrication.

Aerogels are excellent thermal insulators and have other exceptional physical properties. However, the aerogel materials are generally quite fragile and lack strength. There are various ways to strengthen the aerogels, particularly by adding fibers to them when they are made, such as by the well known sol-gel processing, or infiltrating stronger porous structures (e.g., honeycombs, meshes, etc.) with the gel precursor. The combinations of materials make a composite material that has overall improved properties than that of either material by itself.

Such is the case for a composite of organic aerogel and a carbon mesh material, reticulated vitreous carbon (RVC). The aerogel has exceptional optical, thermal, acoustic, and electrical properties, and the RVC has strength; both can be very lightweight. It is possible to make a composite of the aerogel with the RVC by infiltrating the pre-gel precursor of the aerogel, into the already processed RVC foam. However, subsequent processing of the gel (e.g., critical point drying) causes shrinking and cracking of the gel, which may cause poor properties in the composite.

Since the pyrolysis step is common to the formation of both types of materials, i.e., RVC and organic aerogels, it has been determined by the present invention, that it is possible to mix them prior to the pyrolysis step, and then pyrolyze the composite. The advantage is that the shrinkage of the two structures can be made to match, so that a final monolithic material is obtained without cracks due to the pyrolyzation of the materials. The method of this invention is basically carried out by infiltrating an organic gel precursor into a pre-formed organic polymer foam, where it gels, the drying to gel composite so as to minimize shrinkage, on the pyrolyzing the composite in a furnace, reducing it to a glassy carbon form.

### SUMMARY OF THE INVENTION

It is an object of the present invention to provide carbon aerogel composites.

A further object of the invention is to provide a method for producing carbon aerogel composites without cracking or excessive shrinkage.

A further object of the invention is to produce lightweight, high strength carbon aerogel composites.

Another object of the invention is to provide a method for producing lightweight, high strength carbon aerogel composites.

Another object of the invention is to provide a method for the fabrication of carbon aerogel composites wherein an organic gel precursor is infiltrated into a pre-formed organic polymer foam, and allowed to gel, the gel composite is dried so as to minimize shrinkage of the composite, and then heated in a furnace to pyrolyze the composite, thereby reducing the composite to a glassy carbon form.

Other objects and advantages of the present invention will become apparent from the following description. Basically, the invention involves lightweight, high strength carbon aerogel composites and method for fabricating some. The structure of the final carbon product of this invention consists of a matrix of porous carbon aerogel, reinforced by solid carbon struts, all in intimate contact so that the strength of the composite is maximized. This results in lightweight, high strength, carbon aerogel composites. The method involves co-processing structurally different polymers to obtain a composite with improved properties. The method is basically carried out by infiltration of an organic gel precursor into a pre-formed organic polymer foam, where it gels. The gel composite is then dried by any method that minimizes shrinkage of composite material. Whereafter, the dried gel composite is heated in a furnace to pyrolyze the composite, reducing it to a glassy carbon form. The thus formed composite material has applications such as in lightweight thermal protection systems for spacecraft, supersonic and military aircraft, as well as for furnace insulation, fire protection barriers and doors, structural panels for thermal and sound insulation, as well as for use in electronic components, such as supercapacitors.

### DETAILED DESCRIPTION OF THE INVENTION

The present invention is directed to lightweight, strong carbon aerogel composites and to a method for producing such composites. The composites may be utilized as lightweight, high strength insulation material or a material with improved structural material. The method involves co-processing structurally different polymers to obtain a composite with improved properties, as well as enabling the production of reinforced aerogel by co-processing structurally different polymers.

The invention involves a method to obtain a monolithic composite carbon material made from two or more different materials. At least one of the materials is a pre-gel polymer liquid solution, such as an organic gel precursor and at least one of the materials is a polymer foam or a polymer fiber mat such as a pre-formed polymer foam or fiber mat. The liquid is made to infiltrate the pre-formed polymer foam or fiber mat, and time is allowed for the liquid to form a gel or to polymerize so that it encapsulates all or part of the pre-formed material. After a sufficient time for curing, the composite material is dried, either by evaporation or other methods that reduce the surface tensile forces during drying. The composite is then placed in an appropriate furnace for pyrolysis. The pyrolysis step decomposes both of the organic polymers simultaneously reducing them to carbon, so that the shrinkage of each occurs in a manner that essentially maintains contact of the polymers at their interface. After cooling, the final carbon composite will be a nearly contiguous, porous carbon material with a combined structure consisting of the two starting forms.

By way of example, an organic gel precursor solution, composed of resorcinol, formaldehyde, sodium carbonate and water, is infiltrated into a pre-formed organic polymer foam, composed of phenol-formaldehyde resin. Gelation time ranges from 30 to 180 minutes depending on the composition and quantity of the infiltrated materials and at a temperature of 80° C. Drying of the gel/foam composite is then carried out by evaporation for a time period of 12 to 48 hours, depending on the composition and size of the composite. Drying can also be carried out by an method that limits shrinkage of the composite material, such as supercritical drying after fluid exchange with liquid carbon dioxide. The dried gel/foam composite is then heated in a furnace to pyrolize the composite, with a temperature range of 700 to 1100° C. for a time period of 8 to 12 hours, whereby the gel/foam composite is reduced to a monolithic, glassy carbon form. The structure of the final carbon product consists of a matrix of porous carbon aerogel, reinforced by solid carbon struts, all in intimate contact so that the strength of the composite is maximized.

The following is a specific example of the invention. It can be recognized that other organic gel precursors and organic polymer foams or fiber mats may be utilized to form a composite of desired characteristics. In this example, an organic gel solution composed of 12.4 grams of resorcinol, 17.9 grams of 37% formaldehyde solution, 22.3 grams of 0.1 molar sodium carbonate and 45.3 grams of deionized water, is infiltrated into a pre-formed organic polymer foam composed of phenol-formaldehyde resin, gelation temperature is 80° C. and the time is about 110 minutes, the gel composite is dried by supercritical extraction after exchange with liquid carbon dioxide at a temperature of 40° C. and a time period of about 6 hours. The dried composite is then heated in a furnace to a temperature of 900° C., maintained for a time period of 12 hours, and then cooled at a rate of about 10° C./minute, whereby a glassy-carbon composite is formed.

Table 1 shows data for carbon composites of aerogel loaded foam.

TABLE 1
Data for Carbon Composites of Aerogel Loaded Foam

| | Phenolic | Resorcinol | Furan |
|---|---|---|---|
| | resin foam | resin foam | foam |
| Density (kg/m³) | | | |
| - pre-pyrolyzed (un-loaded) | 18 | 78 | 33 |
| - pre-pyrolyzed (loaded with | 93 | 126 | 100 |
| resorcinol-formaldehyde gel) | | | |
| - pyrolyzed @ 750° C., 12 hrs. | 125 | 124 | 115 |
| Modulus (MPa) | | | |
| - pre-pyrolyzed (un-loaded) | 8.8 | 184 | 4.2 |
| - pre-pyrolyzed (loaded with | 4.4 | 169 | 0.56 |
| resorcinol-formaldehyde gel) | | | |
| - pyrolyzed @ 750° C., 12 hrs. | 41.9 | 361 | 29.7 |
| Thermal Conductivity (W/m · K) | | | |
| - pre-pyrolyzed (un-loaded) | 0.034 | 0.037 | 0.069 |
| - pre-pyrolyzed (loaded with | 0.019 | 0.028 | 0.024 |
| resorcinol-formaldehyde gel) | | | |
| - pyrolyzed @ 750° C., 12 hrs. | 0.036 | 0.064 | 0.038 |

It has thus been shown that the present invention overcomes the prior problems associated with the fabrication of organic material composites. This is accomplished primarily by the simultaneous pyrolysis of the two organic polymers, so that the shrinkage of each occurs in a manner that essentially maintains contact of the polymers at their interface. Thus, lightweight, high strength carbon aerogel composites may be produced for applications such as thermal protection systems for spacecraft, etc., or as furnace insulation or fire protective barriers, as well as for thermal and sound insulation, and in electronic components such as supercapacitors.

While particular embodiment, materials, parameters, etc. have been described to exemplify and teach the principles of the inventions, such are not intended to be limiting. Modifications and changes may become apparent to those skilled in the art, and it is intended that the invention be limited only by the scope of the appended claims.

What is claimed is:

1. A method for producing lightweight, high strength carbon aerogel composites, comprising:
infiltrating a polymer liquid into a pre-formed polymer foam, or fiber-mat,
allowing the liquid to gel such that it encapsulates at least part of the pre-formed polymer foam or fiber-mat,
drying the gelled composite such that the surface tensile forces are reduced, and pyrolyzing the dried composite wherein both of the polymers decompose simultaneously such that the polymers remain essentially in contact at their interfaces.

2. The method of claim 1, additionally including forming the polymer liquid from an organic gel precursor.

3. The method of claim 1, additionally including forming the polymer foam into a pre-formed organic polymer form.

4. The method of claim 1, wherein allowing the polymer liquid to gel is carried out at a temperature of 80° C. and a time period of 110 minutes.

5. The method of claim 1, wherein drying the gelled composite is carried out by any method that limits the shrinkage of the gelled composite.

6. The method of claim 1, wherein drying the gelled composite is carried out by evaporation.

7. The method of claim 6, wherein evaporation is carried out at a temperature of 20° C. to 80° C. and for a time period of 12 to 48 hours depending on the composition and size of the gelled composite.

8. The method of claim 1, wherein pyrolyzing the dried composite is carried out in a furnace at a temperature of 700 to 1100° C. and for a time period of 8 to 12 hours.

9. A lightweight aerogel composite material composed of an organic gel precursor infiltrated into a pre-formed organic polymer foam, which is gelled, dried, and pyrolyzed to form a glassy carbon material composed of the two organic materials.

10. The lightweight aerogel composite material of claim 9, consisting of a matrix of porous carbon aerogel, reinforced by solid carbon struts or fibers, all in intimate contact, whereby strength of the composite material is maximized.

11. A method for producing lightweight, strong carbon aerogel composites, comprising:
providing an organic gel precursor,
providing a pre-formed organic polymer foam or fiber-mat,
infiltrating the organic gel precursor into the pre-formed organic foam to form a composite material,
providing for gelation of the thus formed composite material,
drying the thus gelled composite material, and
pyrolyzing the dried composite material, whereby a carbon aerogel composite is produced which consists of a matrix of porous carbon aerogel, reinforced by solid carbon struts, all in intimate contact so that the strength of the composite is maximized.

12. The method of claim 11, wherein drying is carried out by any method that limits the shrinkage of the gelled composite material.

13. The method of claim 11, wherein pyrolyzing is carried out so as to reduce the dried composite material to a glassy carbon form.

14. The method of claim 11, wherein gelation is carried out at a temperature of 20° C. to 80° C. and for a time period of 30 to 180 minutes.

15. The method of claim 11, wherein drying is carried out by evaporation at a temperature of 20° C. to 80° C. and for a time period of 12 to 48 hours.

16. The method of claim 11, wherein pyrolyzing is carried out at a temperature of 700 to 1100° C., and a time period of 8 to 12 hours.

17. The method of claim 11, wherein the organic gel precursor is selected from materials of the group consisting of resorcinol-formaldehyde, phenol-formaldehyde; and wherein the pre-formed organic polymer foam is selected from the group consisting of resorcinol-formaldehyde, phenol-formaldehyde, poly-isocyanates, poly-urethanes, other aromatic hydrocarbons, and heterocyclic compounds, eg. furan.
